(19) United States
(12) Patent Application Publication
(10) Pub. No.: US 2006/0204936 A1
(43) Pub. Date: Sep. 14, 2006

(54) Astrological display method

(76) Inventor: Dan E. Cracraft, Salt Lake City, UT (US)

Correspondence Address: Dan Cracraft, 6358 S. 900 East, Salt Lake City, UT, 84121, US

(21) Appl. No.: 11/074,618

(22) Filed: Mar. 8, 2005

(51) Int. Cl. G09B 19/00

(52) U.S. Cl. 434/106

(57) ABSTRACT

An astrological display method comparing two sets of astrological criteria by means of a vertical to horizontal grid.

### BACKGROUND OF THE INVENTION

While not an exact science, astrology has been in use throughout recorded history as a means of predicting psychological and physical conditions. The first step involves determining the positions of the planets and other celestial phenomena, through observational or mathematical means, as they appear at a given time from a particular location on the Earth. This first set of celestial data generally corresponds to the time and place of an individual's birth and is referred to as a natal chart. This information is usually displayed as a flat, circular map of the sky with the Earth in the center. A second set of celestial data, corresponding to another time and place, is then drawn along the outside of the circular map. If another person's natal chart is used as the second set of data, astrological compatibility between the two people can be evaluated by analyzing the relationships between individual items in the data sets. Current or future conditions are predicted by comparing the first (natal) data set with current or future positions of celestial phenomena (transit chart). This method of displaying astrological information is limited in several ways, including the inability to display all the information from two data sets on one form, difficulty in readily observing the aspects (angles) between individual data points, lack of any means to score the astrological pros and cons of the data being analyzed, and the need for extensive astrological study prior to such a display being of any use to a novice.

### SUMMARY OF THE INVENTION

The astrological display method described here presents the two sets of astrological data described above along the left side and near the top, respectively, of a checkerboard-like grid. The main data boxes along the left and near top (herein referred to as planet boxes) show the astrological sign and house position for each planet or other astrological criteria having a real or hypothetical location in space (herein referred to as an object). The specific astrological information involved in the interaction between any two of these objects can then be presented in the grid square to the right of one object and directly below the other. This information can include the angle (in degrees) between the two objects, an aspect symbol corresponding to that angle, the house numbers where the objects appear in the other data set, and subjective scores defining the quality of the interaction between the two objects being compared. This makes it possible to display all the planet, sign, house and angle information for two data sets in a single image, readily observe the exact angle (aspect) between objects, as well as providing a means of scoring the quality of the relationships being analyzed. Scores, rows and columns can be augmented with associated colors to assist rapid interpretation. Due to this scoring feature, absent in any other astrological display method, even non-astrologers can interpret this display with minimal instruction.

### BRIEF DESCRIPTION OF THE DRAWINGS

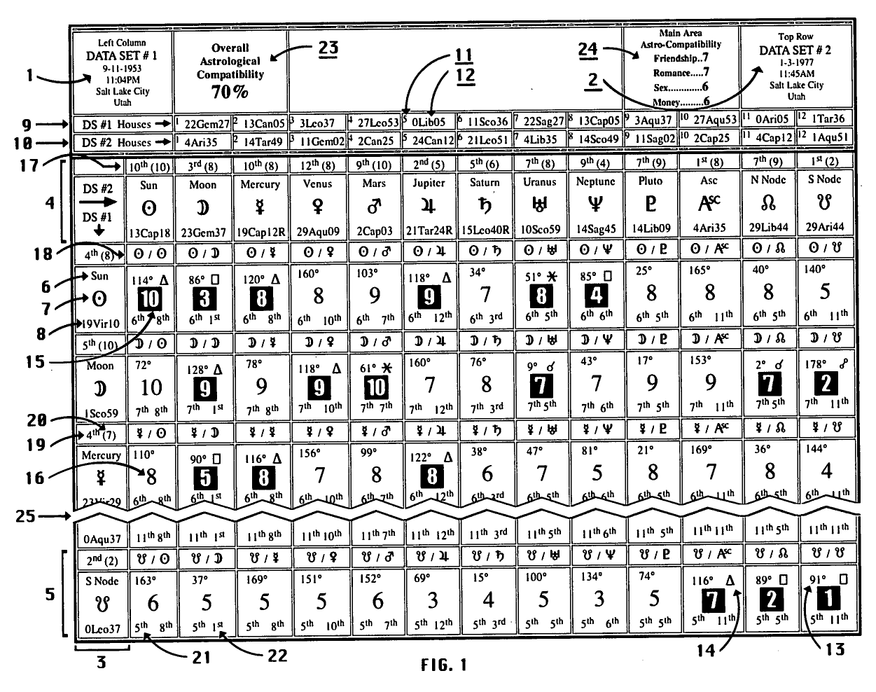

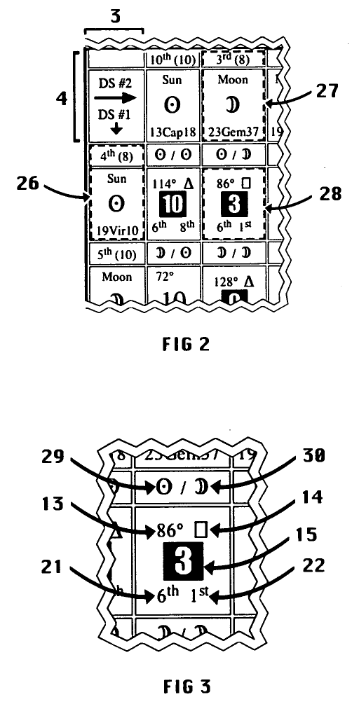

There are three drawings: FIG. 1 is a complete view of the display method in black and white, truncated to remove predictable information. FIG. 2 shows the fundamental operation of the display method where the example is a left side Sun position compared to a Moon position located above. FIG. 3 details the information presented for the planetary relationship compared in FIG. 2.

1 Source information for Data Set # 1

2 Source information for Data Set # 2

3 Data Set # 1 planet box column

4 Data Set # 2 planet box row

5 Planet row

6 Planet (object) name

7 Planet (object) symbol

8 Planet (object) degree/sign/minute

9 Data Set # 1 house cusps

10 Data Set # 2 house cusps

11 House number

12 House degree/sign/minute

13 Angle (aspect) between compared objects

14 Aspect (angle) symbol

15 Object relationship score involving aspect within orb

16 Object relationship score where aspect is NOT within orb

17 Data Set # 2 planet box house position/score row

18 Comparison Guide row (follows after planet box)

19 Data Set # 1 object (Mercury) in Data Set # 1 house # (4^{th})

20 Score for Data Set # 1 object (Mercury) in DS 2 house (score is 7)

21 Data Set # 1 object (S. Node) in Data Set # 2 house # (5^{th})

22 Data Set # 2 object (Moon) in Data Set # 2 house # (1^{st})

23 Space for overall score

24 Space for main area scores

25 Indicates missing material following pattern shown

26 Data Set # 1 Sun planet box

27 Data Set # 2 Moon planet box

28 Comparison Box (Data Set # 1 Sun compared to Data Set #2 Moon)

29 Data Set #1 object symbol (Sun)

30 Data Set #2 object symbol (Moon)

### DETAILED DESCRIPTION

(1) and (2) show the source information of the two Data Sets (DS) used to derive the information presented in the remaining display area. Each data set source (DS 1 and DS 2) consists of a date, time and physical location on the Earth, which is used to determine the apparent location of the planets and other astrological information through standard astrological means, usually a computer program. This information includes the sign and degree of the planets, ascendant, nodes of the Moon, and house cusps for both data sets. The use of other astrological data, ie, Chiron, asteroids, stars, etc., is anticipated but not presented here.

The data source can relate to an individual's time and place of birth (natal data) or any other time and place. When the birth data of two individuals are used as the source of the data sets, the display can be used to present astrological compatibility information. When a past or future time and place are used as data set 2, the display can provide astrological information comparing data set 1 to past or future conditions.

(3) indicates a vertical column of planet boxes containing the specific information for each object in the DS 1 data set.

(4) indicates the horizontal row of planet boxes for DS 2.

(5) shows the height of an entire DS 1 planet box (all one color in color displays) including the (19) house number where the DS 1 object is located in the DS 1 data set, and a (20) score in parenthesis corresponding to the quality of the object being positioned in a particular DS 2 house. (21) shows the DS 2 house position for the DS 1 object from which the score in (20) is derived. For example: Position (19) on the bottom row in FIG. 1 shows that the DS 1 S. Node is in the DS 1 second house. Position (20) shows a score of 2 in parenthesis, this score being derived from the DS 1 S. Node being located in the DS 2 fifth house (21).

(6) is the name of the object within a planet box.

(7) is the astrological symbol for the object within a planet box.

(8) is the degree/sign/minute of the object within a planet box.

(9) shows the row of house cusp information for DS 1.

(10) shows the house cusp information for DS 2.

(11) indicates the house cusp for the degree/sign/minute information displayed in each particular house cusp box.

(12) shows the degree/sign/minute of the house cusp for each house.

(13) indicates the angle between the two objects being compared.

(14) shows the aspect symbol associated with the angle (13) if applicable.

(15) is a score symbol. The presence of a score symbol (a number within a dark square in this example) indicates that the angle between the two objects being compared is within orb of a given aspect. (Orb refers to plus or minus a certain number of degrees from an exact angle.) This score is derived, by an astrologer skilled in the art, by assigning a subjective value to the quality of interaction between the two particular objects when related by the aspect involved. The relative house positions and signs of the two objects can also be applied to determine this score.

(16) is a non-aspect score, where the angle between the planets is out of orb and house position/sign information alone is used to determine the score.

(17) is the object house position and house position score row for DS 2 objects.

(18) shows a guide row, within or above a planet box, which uses object symbols to indicate which two objects are being compared in the box below. The symbol on the left refers to the DS 1 object, followed by a slash, then the symbol for the DS 2 object.

(19) and (20) are described in paragraph

above.

(21) indicates which DS 2 house the DS 1 object is located in.

(22) indicates which DS 1 house the DS 2 object is located in.

(23) is a space provided for an overall score based upon the individual scores from the display, which may be weighted according to significance.

(24) is a space provided for main area scores derived from selected scores elsewhere in the display.

(25) indicates missing material, similar to that material shown, which can be inferred from the pattern of information presented.

In FIG. 2 the DS 1 Sun (26) is compared to the DS 2 Moon (27) with the resulting information displayed in the DS 1 Sun/DS 2 Moon comparison box (28) located to the right of the DS 1 Sun and below the DS 2 Moon.

FIG. 3 provides an enlarged view of the DS 1 Sun/DS 2 Moon comparison box. At the top are the guide symbols which assist understanding which two objects are being compared. (29) is the DS 1 Sun symbol, followed by a slash, then the (30) DS 2 Moon symbol. (13) is the angle between the two objects (860) and (14) is the aspect symbol related to that angle (square). (21) indicates that the DS 1 object (Sun) is in the ₆th house of the DS 2 data set, and (22) shows that the DS 2 object (Moon) is in the ₁St house of the DS 1 data set. A score symbol (15) is present indicating that the angle between the two objects is within orb, the score being a subjective value related to the quality of the interaction between the two objects.

This display method can be implemented by first performing the astrological calculations required to derive the positions of the planets, nodes, ascendant and house positions for both DS 1 and DS 2. (It is anticipated that other astrological data can be displayed in a similar fashion.) The display form can be drawn or programmed according to FIG. 1 and the data can be entered manually or with the aid of a computer program designed for this purpose. Scores are determined by applying the principles of astrology as they relate to the data being analyzed according to the subjective evaluations of an astrologer skilled in the art.

Various colors can be associated with scores and other elements to aid in ease of use.

By providing scores associated with the relationship of each DS1 object to each DS 2 object, and their related positions within signs and houses, it becomes possible for non-astrologers to interpret hundreds of individual astrological variables with minimal instruction.

When the display is generated by computer and displayed on an interactive screen, brief instructions or full text descriptions for each part of the display can be user accessed by clicking upon or otherwise activating individual areas of the display. Such user interaction makes it possible for non-astrologers to quickly access useful understanding of astrological data with no previous knowledge of the subject. This electronic, interactive version is the preferred method of embodiment.

1) An astrological display method comparing two sets of astrological criteria by means of a vertical to horizontal grid. [FIG 1]

2) Display of subjective scores indicative of the quality or nature of the relationship between two planets or other astrological criteria having real or hypothetical locations in space. [FIG 1, 15 and 16]

3) Display of subjective scores related to groups of astrological comparative criteria. [FIG 1, 23 and 24]

4) Display of related astrological text by means of mouse click, rollover or other activation method applied to an astrological symbol or data point within an electronic display.

5) Display of astrological symbols and data within rectangular boxes arranged as shown in:
a) all of FIG. 1
b) FIGS. 1; 6, 7, 8 and FIGS. 2; 26
c) FIGS. 2; 26, 27 and 28
d) FIGS. 3; 13, 14, 15, 21 and 22
